(19) United States
(12) Patent Application Publication
(10) Pub. No.: US 2016/0072792 A1
(43) Pub. Date: Mar. 10, 2016

(54) VERIFICATION METHOD, APPARATUS, SERVER AND SYSTEM

(71) Applicant: TENCENT TECHNOLOGY (SHENZHEN) COMPANY LIMITED, Shenzhen (CN)

(72) Inventors: Shuai HU, Shenzhen (CN); Kaiyuan GU, Shenzhen (CN)

(73) Assignee: TENCENT TECHNOLOGY (SHENZHEN) COMPANY LIMITED, Shenzhen (CN)

(21) Appl. No.: 14/945,608

(22) Filed: Nov. 19, 2015

Related U.S. Application Data
(63) Continuation of application No. PCT/CN2013/091262, filed on Dec. 31, 2013.

(30) Foreign Application Priority Data
May 23, 2013 (CN) 201310196673.4

(51) Int. Cl. H04L 29/06; G06F 21/31

(52) U.S. Cl. CPC H04L 63/08; G06F 21/31

(57) ABSTRACT

Disclosed are a verification method, apparatus, server and system. The method includes: receiving a service request from a terminal; acquiring service data according to the service request received from the terminal; generating a verification question and a standard answer according to the service data; and interacting with the terminal according to the verification question and the standard answer to complete a verification process. The verification question and the standard answer are generated according to the service feature of the service requested by the terminal, and interaction is performed with the terminal according to the verification question and the standard answer to complete the verification process, thereby solving the problem that the network service security cannot be ensured using the verification code technology due to attacks launched by combining the machine and the manpower.

This application claims priority to Chinese Patent Application No. 201310196673.4, filed before Chinese Patent Office on May 23, 2013, and entitled “METHOD, APPARATUS, SERVER, SERVICE DATA CENTER AND SYSTEM FOR VERIFICATION”, which is incorporated herein by reference in its entirety.

### TECHNICAL FIELD

The present disclosure relates to the field of network technologies, and particularly, to a verification method, apparatus, server and system.

### BACKGROUND

With the development of the network technologies, data interaction services performed by the user using network services are more and more extensively used. However, hackers largely destroy the network-provided services using some machine programs. For example, hackers continuously send service requests and responses to a server to cause the server to functionally crash down, or violently crack users' accounts and passwords to steal virtual properties thereof. In view of such problems, it is desired that the network be able to distinguish whether the user is a person or a computer.

The CAPTCHA (Completely Automated Public Turing test to tell Computers and Humans Apart) algorithm is a public automatic program for distinguishing whether the user is a person or a computer, and may effectively solve the above problem. The direct computer recognition may be effectively prevented by putting randomly generated character information into pictures, distorting the character information and adding some noises thereto. However, it may only be distinguished whether the user is a computer or a person by artificially recognizing the character information to achieve an effect of ensuring the network service security.

In the process of implementing the embodiments of the present disclosure, the inventor finds that the related art at least has the following defects: with the development of the artificial intelligence and image processing technology, the computer has an increasingly stronger capability of recognizing the character information in an image. In addition, with the occurrence of the professional captcha human bypass workers, the hackers may directly and artificially recognize the verification code, and the combination of the machine and the manpower causes the verification code to lose its function of ensuring the network services security.

### SUMMARY

In view of the above, embodiments of the present disclosure provide a verification method and device, a server and a system. The technical solutions are described as follows.

In a first aspect, a verification method is provided, including:

receiving a service request from a terminal;

acquiring service data according to the service request received from the terminal, the service data being a set of service features of a service requested by the terminal;

generating a verification question and a standard answer according to the service data; and

interacting with the terminal according to the verification question and the standard answer to complete a verification process.

In a second aspect, a verification apparatus is provided, including: a receiving module, configured to receive a service request from a terminal; an acquiring module, configured to acquire service data according to the service request received by the receiving module from the terminal, the service data being a set of service features of a service requested by the terminal; a generating module, configured to generate a verification question and a standard answer according to the service data acquired by the acquiring module; and a verifying module, configured to interact with the terminal according to the verification question and the standard answer generated by the generating module to complete a verification process.

In a third aspect, a server is provided, including: one or more processors; and a memory; where the memory stores one or more programs configured to be executed by the one or more processors, the one or more programs including instructions for performing the operations of:

receiving a service request from a terminal;

acquiring service data according to the service request received from the terminal, the service data being a set of service features of a service requested by the terminal;

generating a verification question and a standard answer according to the service data; and

interacting with the terminal according to the verification question and the standard answer to complete a verification process.

In a fourth aspect, a verification system is provided, including a server and a terminal connected to each other over a wireless or wired network.

The server is configured to: receive a service request from a terminal; acquire service data according to the service request received from the terminal, the service data being a set of service features of a service requested by the terminal; generate a verification question and a standard answer according to the service data; and interact with the terminal according to the verification question and the standard answer to complete a verification process.

In a fifth aspect, a verification system is provided, including a service data center, a server and a terminal. The service data center and the server are connected to each other over a wireless or wired network; the server and the terminal are connected to each other over a wireless or wired network; and the service data center and the terminal are connected to each other over a wireless or wired network.

The service data center is configured to: receive a service request from a terminal; acquire service data according to the service request received from the terminal, the service data being a set of service features of a service requested by the terminal; generate a verification question and a standard answer according to the service data; and send the verification question and the standard answer to a server, such that the server interacts with the terminal to complete a verification process.

The technical solutions according to the embodiments of the present disclosure achieve the following beneficial effects:

A verification question and a standard answer are generated according to the service features of a service requested by the terminal, and interaction is performed with the terminal according to the verification question and the standard answer to complete the verification process, thereby solving the problem that the network service security cannot be ensured using the verification code technology due to attacks launched by combining the machine and the manpower, and achieving an effect that the network service security is ensured even if the hackers launch attacks by combining the machine and the manpower.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a flowchart of a verification method according to an embodiment of the present disclosure;

FIG. 2 is a flowchart of a verification method according to another embodiment of the present disclosure;

FIG. 3 is a schematic structural diagram of an implementation environment of the verification method according to another embodiment of the present disclosure;

FIG. 4 is a flowchart of a verification method according to still another embodiment of the present disclosure;

FIG. 5 is a schematic structural diagram of an implementation environment of the verification method according to still another embodiment of the present disclosure;

FIG. 6 is a structural block diagram of a verification apparatus according to an embodiment of the present disclosure;

FIG. 7 is a structural block diagram of a verification apparatus according to another embodiment of the present disclosure;

FIG. 8 is a structural block diagram of a verification apparatus according to still another embodiment of the present disclosure;

FIG. 9 is a structural schematic diagram of a verification system according to an embodiment of the present disclosure;

FIG. 10 is a structural schematic diagram of a verification system according to another embodiment of the present disclosure; and

FIG. 11 is a structural schematic diagram of a server or a service data center according to an embodiment of the present disclosure.

### DETAILED DESCRIPTION

To make the objectives, technical solutions and advantages of the present disclosure clearer, embodiments of the present disclosure are further described in details with reference to the drawings.

In the process of using some network services, a user needs identity verification using a terminal and a server providing the network services, and uses the network services only when the identity verification is successful. However, if the user's identity information is stolen by the hackers, they may continuously access a server of the website using some machine programs and cause the server of the website to crash down. Some hackers steal the user's identity verification information using some violent cracking programs, and therefore the user's network virtual properties may be subject to loss or damage. In order to prevent the network service resources from unauthorized use and ensure the security of the user's network virtual properties, the server providing network services shall distinguish whether the user is a person or a computer.

Referring to FIG. 1, a flowchart of a verification method according to an embodiment of the present disclosure is illustrated. The method includes the following steps: Step 101: Receiving a service request from a terminal.

A server receives the service request from the terminal.

Step 102: Acquiring service data according to the service request received from the terminal.

The server acquires the service data according to the service request received from the terminal, the service data being a set of service features of a service requested by the terminal.

Step 103: Generating a verification question and a standard answer according to the service data.

The server generates the verification question and the standard answer according to the user data.

Step 104: Interacting with the terminal according to the verification question and the standard answer to complete a verification process.

The server interacts with the terminal according to the verification question and the standard answer to complete the verification process.

In conclusion, with the verification method according to the embodiment of the present disclosure, the verification question and the standard answer are generated according to the service feature of the service requested by the terminal, and interaction is performed with the terminal according to the verification question and the standard answer to complete a verification process, thereby solving the problem that the network service security cannot be ensured using the verification code technology due to attacks launched by combining the machine and the manpower, and achieving an effect that the network service security is ensured even if the hackers launch attacks by combining the machine and the manpower.

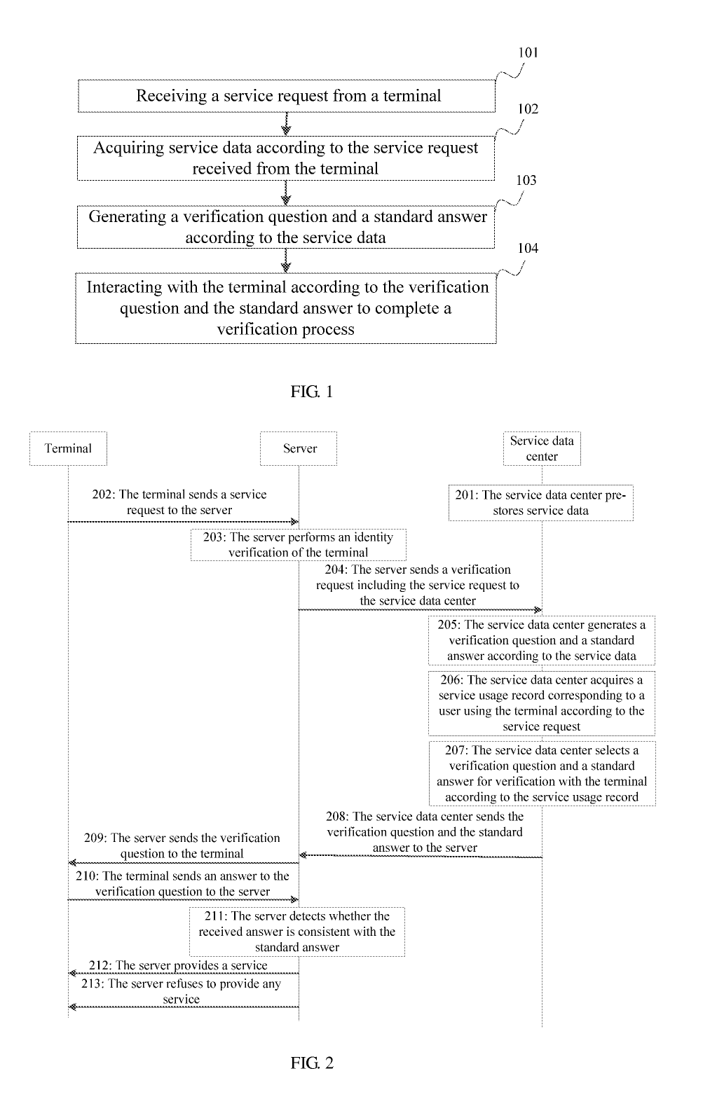

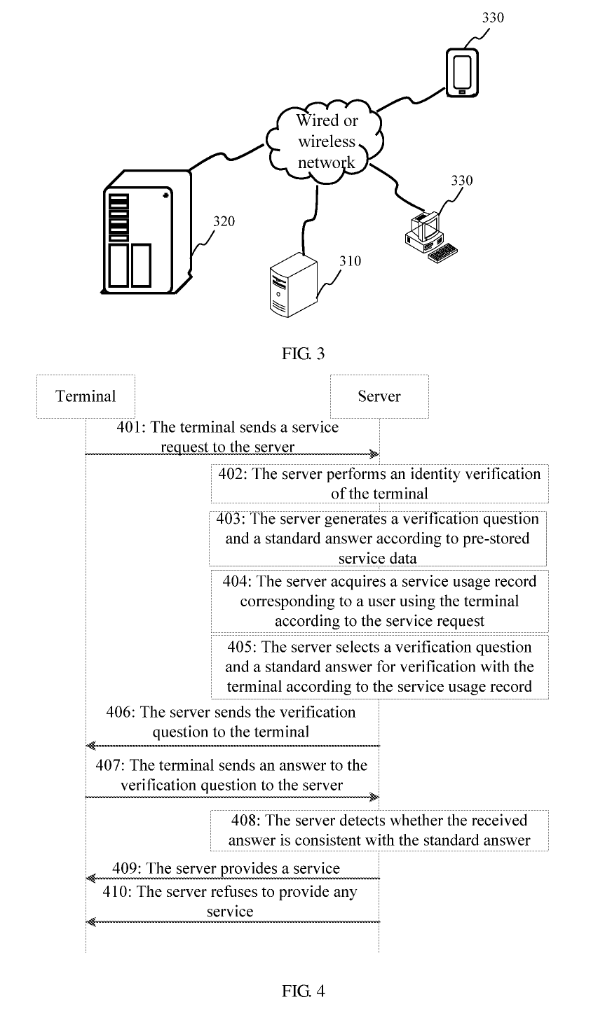

Referring to FIG. 2, a flowchart of a verification method according to another embodiment of the present disclosure is illustrated. The embodiment is described using an example where the verification method is applied to an implementation environment as shown in FIG. 3, where a server 310, a service data center 320, and a terminal 330 are included. The terminal may be any one of a desktop computer, a laptop computer, a smartphone, and a tablet computer. The verification method includes the following steps:

Step 201: A service data center pre-stores service data.

The service data center 320 pre-stores service data, which is a set of service features of the service. The service feature includes at least one of a condition of starting the service function in the service, a restricted attribute when the service function in the service is used, a unique feature of the service function in the service, and a service feature of other service on the same platform as the service. The service data center 320 may acquire the above service data by interacting with the server 310 for providing various services.

When the service is an XX music service, the service data may include a condition of starting the service function in the XX music service, e.g., a condition of starting a function of sharing music with friends in the XX music service.

When the service is an XX microblogging service, the service data may include a restricted attribute when the service function in the XX microblogging service is used, e.g., a word limit of each microblog when a function of tweeting a microblog in the XX microblogging service is used. When the service is an X-chat service, the service data may include a unique feature of the service function in the X-chat service, e.g., an operation of finding friends in the X-chat service.

When the service is XX chat service, the service data may include a service feature of other service on the same platform as the XX chat service, e.g., a service feature of an XX space service of a service on the same platform as the XX chat service.

It should be noted that, the service feature included in the service data varies with the service. The service data center stores a set of service features of different services.

Step 202: The terminal sends a service request to the server.

When using a network service, the user firstly sends a service request including user information for uniquely recognizing a user identity to the server 310 which provides the service, so as to request the server 310 to provide the network service. For example, when the user desires to use the XX music service, the user may send a service request to the server 310 which provides the XX music service over the terminal 330.

Correspondingly, the server 310 receives the service request from the terminal 330.

Step 203: The server performs an identity verification of the terminal.

Upon receiving the service request from the terminal 330, the server 310 firstly performs an identity verification of the terminal 330 according to the user information in the service request.

Step 204: The server sends a verification request including the content of the service request to the service data center.

Upon performing the identity verification of the user, the server 310 sends a verification request including the content of the service request to the service data center 320, the verification request requesting a verification question and a standard answer based on the service data of the service requested by the service request.

Correspondingly, the service data center 320 receives the verification request.

It should be noted that, the verification request sent from the server to the service data center may further include verification level information, i.e., a difficulty level of the verification question requested. For example, when the service requested by the service request received from the terminal concerns relatively important information, the server may apply for a verification question of higher level, such that the service data center generates a verification question of higher level after processing the service data.

Step 205: The service data center generates a verification question and a standard answer according to the service data.

The service data center 320 generates a verification question and a standard answer according to the service data of the service requested by the terminal.

When the service feature includes the condition of starting the service function in the service requested by the user, the contents concerned in the verification question and the standard answer include the condition of starting the service function in the service requested by the user. For example, when the service requested by the user is an XX music service, the contents involved in the verification question and the standard answer include “what is the condition of starting the function of sharing music with friends in the XX music service” (the standard answer is assumed as reaching the 20^{th} level), or “what is the condition of providing a music service of high quality in the XX music service” (the standard answer is assumed as that the user desires to open a diamond channel).

When the service feature includes the restricted attribute when the service function in the service requested by the user is used, the service data center 320 generates the verification question and the standard answer, and the contents concerned therein include the restricted attribute when the service function in the service requested by the user is used. For example, when the service requested by the user is an XX microblogging service, the contents concerned in the verification question and the standard answer include “how many Chinese characters can be input at most in each microblog when a function of tweeting a microblog in the XX microblogging service is used” (the standard answer is assumed as 140 Chinese characters), “or whether a picture can be inserted when a comment function in the XX microblogging service is used” (the standard answer is assumed as “No”).

When the service feature includes the unique feature of the service function in the service requested by the user, the service data center 320 generates the verification question and the standard answer, and the contents concerned therein include the unique feature of the service function in the service requested by the user. For example, when the service requested by the user is an X-chat service, the contents concerned in the verification question and the standard answer may include “what operation shall be made to find friends in the X-chat service” (the standard answer is assumed as shaking the cell phone), or “whether the information of friends nearby can be obtained in the X-chat service” (the standard answer is assumed as “Yes”).

When the service feature includes an attribute of other service on the same platform as the service requested by the user, the service data center 320 generates the verification question and the standard answer, and the contents involved therein include the content of the other service on the same platform as the service requested by the user. For example, when the service requested by the user is XX chat service, the contents concerned in the verification question and the standard answer include “what are the names of the services provided by the platform for the XX chat service” (the standard answer is assumed as XX mailbox and XX game), or “what roles are provided in XX game of the platform for the XX chat service” (the standard answer is assumed as officials and robbers).

It is assumed that the verification question generated by the service data center 320 is “what is the condition of starting the function of sharing music with friends in the XX music service” (the standard answer is assumed as reaching the 20^{th} level).

It should be noted that, the verification question and the standard answer are generated according to the service feature of the service requested by the user, and are not limited to the above contents. Preferably, the service data center 320 may distinguish various difficulty levels for the generated verification questions and standard answers.

Step 206: the service data center acquires a service usage record corresponding to a user using the terminal according to the service request;

preferably, when the verification request sent from the server 310 to the service data center 320 does not contain the verification level information, the service data center 320 can select the verification question and the standard answer to be provided to the server 310 by itself, such that the verification question better meets the user's service usage record, and improve the accuracy of the user's answer to the verification question.

The service data center 320 acquires the service usage record corresponding to the user using the terminal 330 according to the service request received from the terminal 330. The service usage record includes a service function most frequently or most recently used by the user. For example, according to user information in the service request received from the terminal 330, the service data center 320 acquires the service usage record corresponding to the user information, including a service function most frequently or most recently used by the user. It is assumed that the service function most frequently used by the user is an XX microblog, and the service function most recently used by the user is an XX music.

Step 207: The service data center selects a verification question and a standard answer for verification with the terminal according to the service usage record.

The service data center 320 selects the verification question and the standard answer for verification with the terminal 330 according to the service usage record acquired in step 206. It is assumed that the service usage record acquired by the service data center 320 in step 206 is the service function most recently used by the user, the service data center 320 selects the verification question and the standard answer for verification with the terminal according to the service function most recently used by the user. For example, the verification question selected by the service data center 320 is “what is the condition of starting the function of sharing music with friends in the XX music service” (the standard answer is assumed as reaching the 20^{th} level).

It should be noted that, the service data center may also select the verification question and the standard answer for verification with the terminal according to the service function most frequently used by the user. The embodiment is described using an example where the service data center selects the verification question and the standard answer for verification with the terminal according to the service function most recently used by the user.

Step 208: the service data center sends the verification question and the standard answer to the server.

The service data center 320 can randomly select the verification question and the standard answer to be sent to the server 310. Preferably, the service data center 320 may select the verification question and the standard answer and send them to the server 310 according to the following two policies:

When the verification request sent from the server 310 to the service data center 320 contains the verification level information, the service data center 320 may select the verification question and the standard answer matching a difficulty level indicated by the verification level information, and send them to the server 310.

When the verification request sent from the server 310 to the service data center 320 does not contain the verification level information, the service data center 320 sends the verification question and the standard answer selected in steps 206 and 207 to the server 310, such that the server 310 interacts with the terminal 330 to complete the verification process. For example, the service data center 320 sends the verification question and the standard answer selected in step 207, i.e., “what is the condition of starting the function of sharing music with friends in the XX music service” (the standard answer is assumed as reaching the 20^{th} level), to the server 310.

Correspondingly, the server 310 receives the verification question and the standard answer from the service data center.

Step 209: The server sends the verification question to the terminal.

Upon receiving the verification question and the standard answer from the service data center 320, the server 310 sends the verification question to the terminal 330. For example, the server 310 sends “what is the condition of starting the function of sharing music with friends in the XX music service” to the terminal 330.

It should be noted that, the server may also send the verification question to the terminal in the form of a choice question, i.e., providing multiple answers for the terminal to select a correct one therefrom. For example, the server 310 sends “selecting the condition of starting the function of sharing music with friends in the XX music service from the following options: A. reaching the 20^{th} level; B. the VIP user; C. reaching the 10^{th} level” to the terminal 330. The embodiment of the present disclosure is described using an example where the server sends the verification question to the terminal in the form of a choice question.

Correspondingly, the terminal 330 receives the verification question from the server 310.

Step 210: The terminal sends an answer to the verification question to the server.

The user answers the question according to his usage experience of the service requested, and sends the answer to the question to the server 310 over the terminal 330. For example, the user sends the answer to the question, i.e., “reaching the 20^{th} level”, to the server 310 over the terminal 330.

When the server 310 sends the verification question to the terminal 330 in the form of a choice question, the user selects the correct answer according to his usage experience of the service requested, and sends the same to the server 310 over the terminal 330.

Correspondingly, the server 310 receives the answer to the verification question from the terminal 330.

Step 211: The server detects whether the received answer is consistent with the standard answer.

The server 310 detects whether the answer sent by the user using the terminal 330 is consistent with the standard answer sent by the service data center 320; if consistent, the process enters step 212; otherwise, the process enters step 213.

Step 212: The server provides a service.

When a detection result of the server 310 indicates that the received answer is consistent with the standard answer, a service is provided. For example, the server 310 provides the XX music service, and the user may log in to the XX music for corresponding operations.

Step 213: The server refuses to provide any service.

When a detection result of the server 310 indicates that the received answer is inconsistent with the standard answer, the server refuses to provide any service. For example, the server 310 does not provide the XX music service, and the user cannot log in to the XX music for corresponding operations.

In conclusion, with the verification method according to this embodiment, the verification question and the standard answer are generated according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

In the embodiment, the service data center further selects the verification question and the standard answer provided to the server and the terminal using the service usage record, i.e., the service function most frequently or most recently used by the user. The verification question and the standard answer are private to the user, and the professional captcha human bypass workers usually cannot acquire the standard answer to the verification question, and thus the network service security can be better ensured.

Referring to FIG. 4, a flowchart of a verification method according to still another embodiment of the present disclosure is illustrated. This embodiment is described using an example where the verification method is applied to an implementation environment as shown in FIG. 5, where a server 510 and a terminal 520 are included. The terminal may be any one of a desktop computer, a laptop computer, a smartphone and a tablet computer. Different from the previous embodiment, in this embodiment the server generates a verification question and a standard answer according to the pre-stored service data, and then interacts with the terminal according to the generated verification question and standard answer to complete a verification process, rather than “the service data center generates a verification question and a standard answer, and then sends the verification question and the standard answer to the server, such that the server interacts with the terminal to complete a verification process”. The verification method includes:

Step 401: The terminal sends a service request to the server.

When using a network service, the user firstly sends a service request including user information for uniquely recognizing a user identity to the server 510 which provides the service, so as to request the server 510 to provide the network service. For example, when the user desires to use the XX chat service, the user may send a service request to the server 510 which provides the XX chat service over the terminal 520.

Correspondingly, the server 510 receives the service request from the terminal 520.

Step 402: The server performs an identity verification of the terminal.

Upon receiving the service request from the terminal 520, the server 510 firstly performs an identity verification of the terminal 520 according to the user information in the service request.

Step 403: The server generates a verification question and a standard answer according to pre-stored service data.

Upon performing a successful identity verification of the terminal, the server 510 generates a verification question according to pre-stored service data, which is a set of service features of the service provided by the server. The service feature includes at least one of a condition of starting the service function in the service, a restricted attribute when the service function in the service is used, a unique feature of the service function in the service, and a service feature of other service on the same platform as the service. For instance, the embodiment is described using an example where the service requested by the terminal is an XX chat service. When the service requested by the terminal is the XX chat service, it is assumed that the service features of the XX chat service include the condition of starting the service function in the service and the service feature of other service on the same platform as the service.

When the server 510 generates the verification question and the standard answer according to the condition of starting the service function in the service features, the contents concerned in the verification question and the standard answer may include “the level required for using a group chat function in the XX chat service” (the standard answer is assumed as the 18^{th} level).

When the server 510 generates the verification question and the standard answer according to the service feature of other service on the same platform as the service in the service features, since the service on the same platform as the XX chat service may include an XX mailbox, an XX microblog, an XX music, and the like, the server may generate the verification question and the standard answer according to the service feature of at least one service of the XX mailbox, the XX microblog, the XX music, and the like. For example, the contents concerned in the verification question and the standard answer may include “what is the size limit of a mail sent from the XX mailbox” (the standard answer is assumed as 1 MB), “what is the condition of using a comment function in the XX microblog” (the standard answer is assumed as that the user opens a diamond channel), or “whether the XX music provides a download service” (the standard answer is assumed as “Yes”).

It should be noted that, the verification question and the standard answer are generated according to the service feature of the service requested by the user, and they are not limited to the above listed contents. Preferably, the server 510 may further distinguish various difficulty levels for the generated verification questions and standard answers.

Step 404: The server acquires a service usage record corresponding to a user using the terminal according to the service request.

Preferably, the server 510 may select the verification question and the standard answer for verification with the terminal 520 according to the service usage record corresponding to the user using the terminal, such that the verification question better meets the user's service usage record, and improve the accuracy of the user's answer to the verification question.

The server 510 acquires the service usage record corresponding to a user using the terminal 520 according to the service request received from the terminal 520. The service usage record includes a service function most frequently or most recently used by the user. For example, according to user information in the service request received from the terminal 520, the server 510 acquires the service usage record corresponding to the user information, including a service function most frequently or most recently used by the user. It is assumed that the service function most frequently used by the user is XX mailbox, and the service function most recently used by the user is XX music.

Step 405: The server selects a verification question and a standard answer for verification with the terminal according to the service usage record.

The server 510 selects the verification question and the standard answer for verification with the terminal 520 according to the service usage record acquired in step 404. It is assumed that the service usage record acquired by the server 510 in step 404 is the service function most frequently used by the user, the server 510 selects the verification question and the standard answer for verification with the terminal 520 according to the service function most frequently used by the user. For example, the verification question selected by the server 510 is “what is the size limit of a mail sent from the XX mailbox” (the standard answer is assumed as 1 MB).

It should be noted that, the server may also select the verification question and the standard answer for verification with the terminal according to the service function most recently used by the user. The embodiment is described using an example where the service data center selects the verification question and the standard answer for verification with the terminal according to the service function most frequently used by the user.

Step 406: the server sends the verification question to the terminal.

The server 510 sends the verification question selected in step 405 to the terminal 520. For example, the server 510 sends “what is the size limit of a mail sent from the XX mailbox” to the terminal 520.

It should be noted that, the server may also send the verification question to the terminal in the form of a choice question, i.e., providing multiple answers for the terminal to select a correct one therefrom. For example, the server 510 sends “selecting the size limit of a mail sent from the XX mailbox from the following options: A. 1 MB; B. 10 MB; C. 20 MB” to the terminal 520. The embodiment of the present disclosure is described using an example where the server 510 sends the verification question to the terminal 520 in the form of a choice question.

Correspondingly, the terminal 520 receives the verification question from the server 510.

Step 407: the terminal sends an answer to the verification question to the server;

The user answers the question according to his usage experience of the service requested, and sends the answer to the question to the server 510 over the terminal 520. For example, the user sends the answer to the question, i.e., “1 MB”, to the server 510 over the terminal 520.

When the server 510 sends the verification question to the terminal 520 in the form of a choice question, the user selects the correct answer according to his usage experience of the service requested, and sends the same to the server 510 over the terminal 520.

Correspondingly, the server 510 receives the answer to the verification question sent by the terminal 520.

Step 408: The server detects whether the received answer is consistent with the standard answer.

The server 510 detects whether the received answer is consistent with the generated standard answer; if consistent, the process enters step 409; otherwise, the process enters step 410.

Step 409: The server provides a service.

When a detection result of the server 510 indicates that the received answer is consistent with the standard answer, a service is provided. For example, the server 510 provides the XX chat service, and the user can enjoy the XX chat service.

Step 410: The server refuses to provide any service.

When a detection result of the server 510 indicates that the received answer is inconsistent with the standard answer, the server 510 refuses to provide any service. For example, the server 510 does not provide the XX chat service, and the user cannot enjoy the XX chat service.

In conclusion, with the verification method according to this embodiment, the verification question and the standard answer are generated according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

It should be noted that, since the verification question and the standard answer are generated according to the service data in the verification method provided in the embodiment of the present disclosure, the difficulty level of the verification question can be updated based on the actual condition, and a certain logic processing can be performed for the service data in advance, thus the verification method has a strong extensibility and does not require a noise addition processing in the conventional verification code technology. Nevertheless, in certain circumstances, the present disclosure may be combined with the conventional verification code technology and other verification technologies, so as to better protect the network service security.

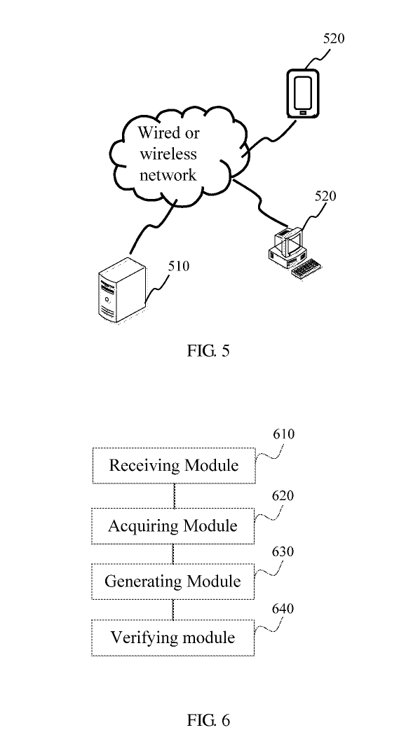

Referring to FIG. 6, a structural block diagram of a verification apparatus according to an embodiment of the present disclosure is illustrated. The verification apparatus may be implemented as the whole or a part of a server or a service data center using software, hardware or a combination thereof.

The verification apparatus includes: a receiving module 610, configured to receive a service request from a terminal; an acquiring module 620, configured to acquire service data according to the service request received by the receiving module 610 from the terminal, the service data being a set of service features of a service requested by the terminal; a generating module 630, configured to generate a verification question and a standard answer according to the service data acquired by the acquiring module 620; and a verifying module 640, configured to interact with the terminal according to the verification question and the standard answer generated by the generating module 630 to complete a verification process.

In conclusion, the verification apparatus according to this embodiment generates the verification question and the standard answer according to the service feature of the service requested by the terminal, and interacts with the terminal according to the verification question and the standard answer to complete a verification process, thereby solving the problem that the network service security cannot be ensured using the verification code technology due to attacks launched by combining the machine and the manpower, and achieving an effect that the network service security is ensured even if the hackers launch attacks by combining the machine and the manpower.

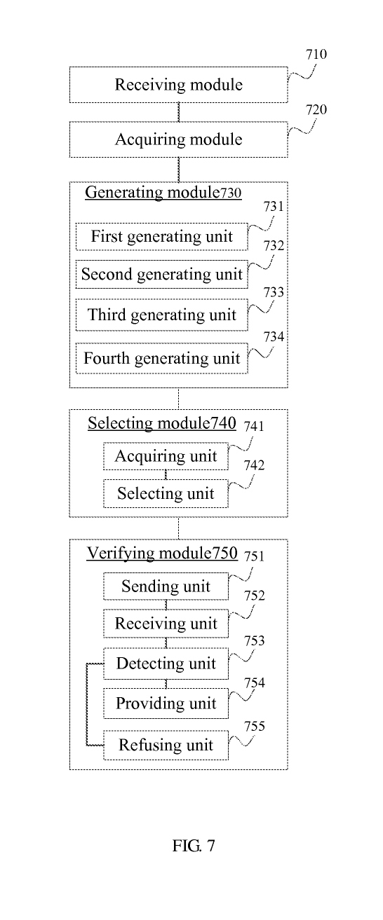

Referring to FIG. 7, a structural block diagram of a verification apparatus according to another embodiment of the present disclosure is illustrated. The verification apparatus may be implemented as the whole or a part of a server using software, hardware or a combination thereof. The verification apparatus includes: a receiving module 710, an acquiring module 720, a generating module 730, a selecting module 740, and a verifying module 750.

The receiving module 710 is configured to receive a service request from a terminal.

The acquiring module 720 is configured to acquire service data according to the service request received from the terminal and received by the receiving module 710, the service data being a set of service features of a service requested by the terminal. The service feature includes at least one of a condition of starting the service function in the service, a restricted attribute when the service function in the service is used, a unique feature of the service function in the service, and a service feature of other service on the same platform as the service.

The generating module 730 is configured to generate a verification question and a standard answer according to the service data acquired by the acquiring module 720.

The generating module 730 includes: at least one of a first generating unit 731, a second generating unit 732, a third generating unit 733, and a fourth generating unit 734.

The first generating unit 731 is configured to generate the verification question and the standard answer when the service feature acquired by the acquiring module 720 includes the condition of starting the service function in the service, where the contents involved in the verification question and the standard answer include the condition of starting the service function in the service.

The second generating unit 732 is configured to generate the verification question and the standard answer when the service feature acquired by the acquiring module 720 includes the restricted attribute when the service function in the service is used, where the contents involved in the verification question and the standard answer include the restricted attribute when the service function in the service is used.

The third generating unit 733 is configured to generate the verification question and the standard answer when the service feature acquired by the acquiring module 720 includes the unique feature of the service function in the service, where the contents involved in the verification question and the standard answer include the unique feature of the service function in the service.

The fourth generating unit 734 is configured to generate the verification question and the standard answer when the service feature acquired by the acquiring module 720 includes an attribute of other service on the same platform as the service, where the contents involved in the verification question and the standard answer include the content of the other service on the same platform as the service.

The selecting module 740 is configured to select, according to the service request received by the receiving module 710, a verification question and a standard answer for verification with the terminal from the verification questions and the standard answers generated by the generating module 730.

The selecting module 740 includes: an acquiring unit 741, configured to acquire a service usage record corresponding to a user using the terminal according to the service request received by the receiving module 710, the service usage record including a service function most frequently or most recently used by the user; and a selecting unit 742, configured to select the verification question and the standard answer for verification with the terminal, according to the service usage record acquired by the acquiring unit 741.

The verifying module 750 is configured to interact with the terminal according to the verification question and the standard answer selected by the selecting module 740 to complete a verification process.

The verifying module 750 includes: a sending unit 751, a receiving unit 752, a detecting unit 753, a providing unit 754, and a refusing unit 755.

The sending unit 751 is configured to send the verification question to the terminal.

The receiving unit 752 is configured to receive from the terminal an answer to the verification question sent by the sending unit 751.

The detecting unit 753 is configured to detect whether the answer received by the receiving unit 752 is consistent with the standard answer.

The providing unit 754 is configured to provide a service when the detection result of the detecting unit 753 indicates that the received answer is consistent with the standard answer.

The refusing unit 755 is configured to refuse to provide any service when the detection result of the detecting unit 753 indicates that the received answer is inconsistent with the standard answer.

In conclusion, the verification apparatus according to the embodiment of the present disclosure generates the verification question and the standard answer according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

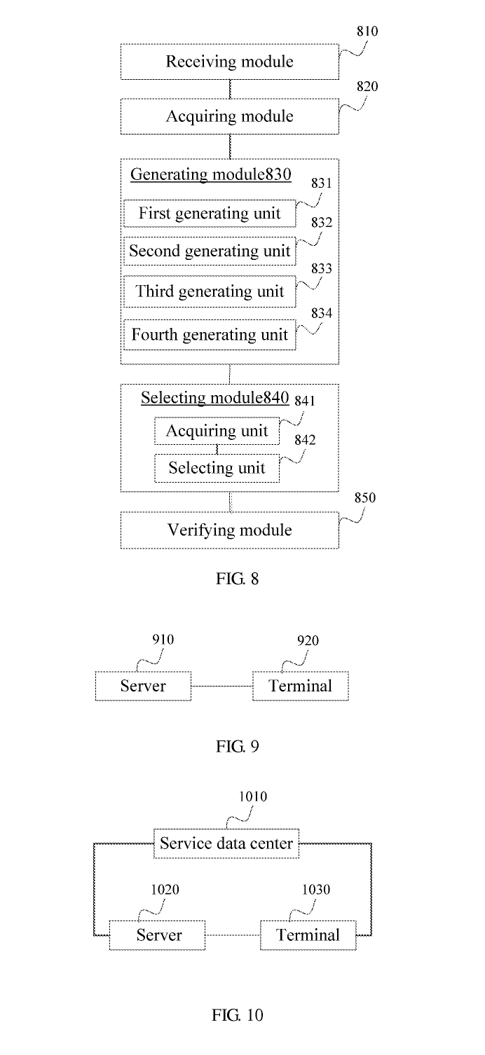

Referring to FIG. 8, a structural block diagram of a verification apparatus according to still another embodiment of the present disclosure is illustrated. The verification apparatus may be implemented as the whole or a part of a service data center by using software, hardware or a combination thereof. The verification apparatus includes: a receiving module 810, an acquiring module 820, a generating module 830, a selecting module 840, and a verifying module 850.

The receiving module 810 is configured to receive a service request from a terminal.

The acquiring module 820 is configured to acquire service data according to the service request received by the receiving module 810 from the terminal, the service data being a set of service features of a service requested by the terminal. The service feature includes at least one of a condition of starting the service function in the service, a restricted attribute when the service function in the service is used, a unique feature of the service function in the service, and a service feature of other service on the same platform as the service.

The generating module 830 is configured to generate a verification question and a standard answer according to the service data acquired by the acquiring module 820.

The generating module 830 includes at least one of a first generating unit 831, a second generating unit 832, a third generating unit 833, and a fourth generating unit 834.

The first generating unit 831 is configured to generate the verification question and the standard answer when the service feature acquired by the acquiring module 820 includes the condition of starting the service function in the service, where the content involved in the verification question and the standard answer include the condition of starting the service function in the service.

The second generating unit 832 is configured to generate the verification question and the standard answer when the service feature acquired by the acquiring module 820 includes the restricted attribute when the service function in the service is used, where the content involved in the verification question and the standard answer include the restricted attribute when the service function in the service is used.

The third generating unit 833 is configured to generate the verification question and the standard answer when the service feature acquired by the acquiring module 820 includes the unique feature of the service function in the service, where the content involved in the verification question and the standard answer include the unique feature of the service function in the service.

The fourth generating unit 834 is configured to generate the verification question and the standard answer when the service feature acquired by the acquiring module 820 includes an attribute of other service on the same platform as the service, where the content involved in the verification question and the standard answer include the content of the other service on the same platform as the service.

The selecting module 840 is configured to select a verification question and a standard answer for verification with the terminal from the verification questions and the standard answers generated by the generating module 830, according to the service request received by the receiving module 810.

The selecting module 840 includes: an acquiring unit 841, configured to acquire a service usage record corresponding to a user using the terminal according to the service request received by the receiving module 810, the service usage record including a service function most frequently or most recently used by the user; and a selecting unit 842, configured to select the verification question and the standard answer for verification with the terminal, according to the service usage record acquired by the acquiring unit 841.

The verifying module 850 is configured to send the verification question and the standard answer selected by the selecting module 840 to the server, such that the server interacts with the terminal to complete a verification process.

In conclusion, the verification apparatus according to the embodiment of the present disclosure generates the verification question and the standard answer according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

Referring to FIG. 9, a schematic structural diagram of a verification system according to an embodiment of the present disclosure is illustrated. The verification system includes a server 910 and a terminal 920, where the server 910 and the terminal 920 are connected to each other over a wireless or wired network.

The server 910 includes a verification apparatus according to the embodiment as illustrated in FIG. 6 or 7.

In conclusion, the verification system according to this embodiment generates the verification question and the standard answer according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

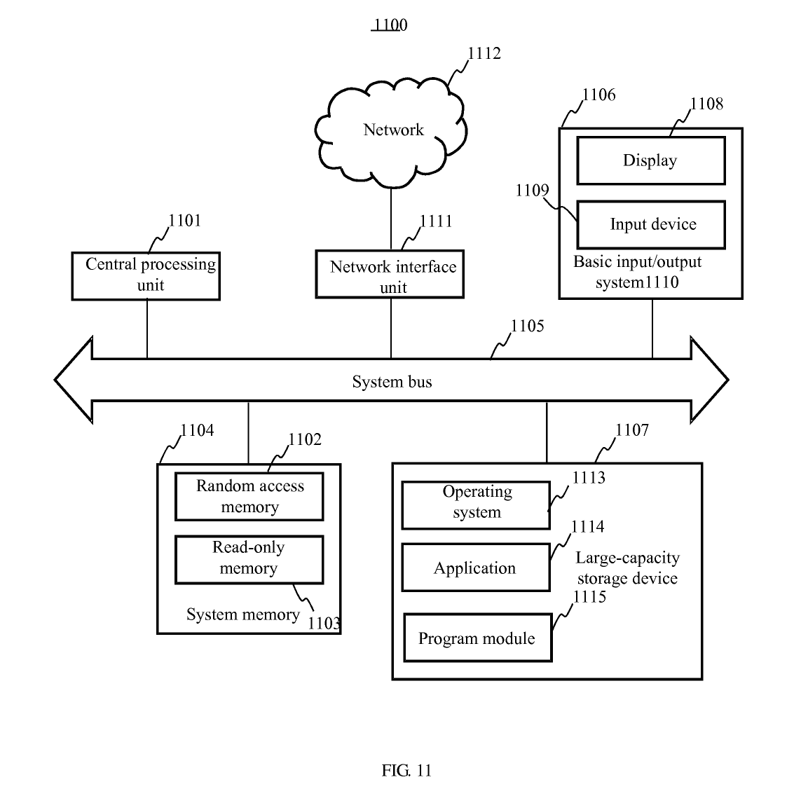

Referring to FIG. 10, a schematic structural diagram of a verification system according to another embodiment of the present disclosure is illustrated. The verification system includes a service data center 1010, a server 1020, and a terminal 1030. The service data center 1010 and the server 1020 are connected to each other over a wireless or wired network. The server 1020 and the terminal 1030 are connected to each other over a wireless or wired network. The service data center 1010 and the terminal 1030 are also connected to each other over a wireless or wired network.

The service data center 1010 includes a verification apparatus according to the embodiment as illustrated in FIG. 6 or 8.

In conclusion, the verification system according to this embodiment generates the verification question and the standard answer according to the pre-stored service data, where the verification question and the standard answer are generated according to the service feature of the service requested by the user in the service data. The generated verification question and standard answer are only known to the user enjoying the service and the server providing the service, and may not be directly acquired by the hackers, thereby solving the problem that the network service security cannot be ensured using the verification code technology due to attacks launched by combining the machine and the manpower, and achieving an effect that the network service security is ensured even if the hackers launch attacks by combining the machine and the manpower.

It should be noted that, when performing the verification, the verification apparatus according to the above embodiment is just described using the example of the division of the functional modules. In practical applications, those functions may be allocated to be performed by different functional modules upon demand, i.e., the internal structure of the device is divided into different functional modules to complete all or a part of the aforementioned functions. In addition, the verification apparatus according to the above embodiment belongs to the same conception as the verification method. For the specific implementation of the verification apparatus, reference may be made to the method embodiment, which is not described herein any further.

Referring to FIG. 11, a schematic structural diagram of a server or a service data center according to an embodiment of the present disclosure is illustrated. The server or the service data center 1100 includes a central processing unit (CPU) 1101, a system memory 1104 including a random access memory (RAM) 1102 and a read only memory (ROM) 1103, and a system bus 1105 connecting the system memory 1104 to the CPU 1101. The server or the service data center 1100 further includes a basic input/output (I/O) system 1106 for facilitating information transmission between various devices in a computer, and a mass storage device 1107 for storing an operating system 1113, an application program 1114, and another program module 1115.

The basic I/O system 1106 includes a display 1108 for displaying information, and an input device 1109 for a user to input information, such as a mouse, a keyboard, and the like. In which, the display 1108 and the input device 1109 are both connected to the CPU 1101 using an I/O controller 1110 that is connected to the system bus 1105. The basic I/O system 1106 may further include the I/O controller 1110 for receiving and processing an input from such a device as a keyboard, a mouse, and an electronic stylus. Similarly, the I/O controller 1110 further provides an output to a display screen, a printer, or another type of output device.

The mass storage device 1107 is connected to the CPU 1101 using a mass storage controller (not illustrated) that is connected to the system bus 1105. The mass storage device 1107 and its associated computer readable medium provide a nonvolatile storage to the server or the service data center 1100. That is, the mass storage device 1107 may include a computer readable medium (not illustrated) such as a hard disc or a compact disc read-only memory (CD-ROM) driver. Typically, the computer readable medium may include a computer storage medium and a communication medium. The computer storage medium includes volatile and non-volatile, movable and unmovable media that are implemented using any method and technology for storing information such as computer-readable instructions, data structures, program modules, or other data. The non-transitory computer-readable medium includes a RAM, a ROM, an EPROM, an EEPROM, a flash memory, or another such solid storage technology-based storage device; a CD-ROM, a DVD, or another such optical storage device; and a data cartridge, a magnetic card, a magnetic tape, or another such magnetic storage device. Nevertheless, a person skilled in the art may know that the non-transitory computer-readable storage medium is not limited to what are listed above The system memory 1104 and the large-capacity storage device 1107 may be uniformly referred to as a memory.

According to the embodiments of the present disclosure, the server or the service data center 1100 may be connected to the remote computer in the network over a network such as the Internet. That is, the server 1100 may be connected to a network 1112 by using a network interface unit 1111 that is connected to the system bus 1105, or the server 1100 may be connected to another type of network or remote computer system (not illustrated) with the network interface unit 1111.

The memory further includes one or more programs stored in the memory and containing the instructions for performing the verification method according to the embodiment of the present disclosure.

The sequence numbers of the preceding embodiments of the present invention are only for ease of description, but do not denote the preference of the embodiments.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a ROM, a magnetic disk, or a compact disc-read only memory.

Detailed above are merely exemplary embodiments of the present disclosure, and are not intended to limit the present disclosure. Any amendment, equivalent replacement, and improvement made under the spirit and principle of the present disclosure shall fall within the protection scope of the present disclosure.

What is claimed is:

1. A verification method, comprising:
receiving a service request from a terminal;
acquiring service data according to the service request received from the terminal, the service data being a set of service features of a service requested by the terminal;
generating a verification question and a standard answer according to the service data; and
interacting with the terminal according to the verification question and the standard answer to complete a verification process.

2. The method according to claim 1, wherein the service feature comprises at least one of a condition of starting a service function in the service, a restricted attribute when the service function in the service is used, a unique feature of the service function in the service, and a service feature of other service on the same platform as the service.

3. The method according to claim 2, wherein the generating a verification question and a standard answer according to the service data comprises:
generating the verification question and the standard answer when the service feature comprises the condition of starting the service function in the service, wherein the contents of the verification question and the standard answer comprise the condition of starting the service function in the service;
generating the verification question and the standard answer when the service feature comprises the restricted attribute when the service function in the service is used, wherein the contents involved in the verification request and the standard answer comprise the restricted attribute when the service function in the service is used;
generating the verification question and the standard answer when the service feature comprises the unique feature of the service function in the service, wherein the contents involved in the verification request and the standard answer comprise the unique feature of the service function in the service; and
generating the verification question and the standard answer when the service feature comprises an attribute of other service on the same platform as the service, wherein the contents involved in the verification request and the standard answer comprise the content of the other service on the same platform as the service.

4. The method according to claim 1, wherein prior to the interacting with the terminal according to the verification question and the standard answer to complete a verification process, the method further comprises:
selecting a verification question and a standard answer for verification with the terminal from the generated verification questions and standard answers according to the service request.

5. The method according to claim 4, wherein selecting a verification question and a standard answer for verification with the terminal from the generated verification questions and standard answers according to the service request comprises:
acquiring a service usage record corresponding to a user using the terminal according to the service request, the service usage record comprising a service function most frequently or most recently used by the user; and
selecting the verification question and the standard answer for verification with the terminal according to the service usage record.

6. The method according to claim 1, wherein the interacting with the terminal according to the verification question and the standard answer to complete a verification process comprises:
sending the verification question to the terminal;
receiving an answer to the verification question from the terminal;
detecting whether the received answer is consistent with the standard answer; and
providing a service when a detection result indicates that the received answer is consistent with the standard answer.

7. The method according to claim 1, wherein the interacting with the terminal according to the verification question and the standard answer to complete a verification process comprises:
sending the verification question and the standard answer to a server, such that the server interacts with the terminal to complete the verification process.

8. A server, comprising:
one or more processors; and
a memory;
wherein the memory stores one or more programs configured to be performed by the one or more processors, the one or more programs comprising instructions for performing the operations of:
receiving a service request from a terminal;
acquiring service data according to the service request received from the terminal, the service data being a set of service features of a service requested by the terminal;
generating a verification question and a standard answer according to the service data; and
interacting with the terminal according to the verification question and the standard answer to complete a verification process.

9. The server according to claim 8, wherein the service feature comprises at least one of a condition of starting a service function in the service, a restricted attribute when the service function in the service is used, a unique feature of the service function in the service, and a service feature of other service on the same platform as the service.

10. The server according to claim 8, wherein the one or more programs further comprise instructions for performing the operations of:
generating the verification question and the standard answer when the service feature comprises the condition of starting the service function in the service, wherein the contents involved in the verification question and the standard answer comprise the condition of starting the service function in the service;
generating the verification question and the standard answer when the service feature comprises the restricted attribute when the service function in the service is used, wherein the contents involved in the verification question and the standard answer comprise the restricted attribute when the service function in the service is used;
generating the verification question and the standard answer when the service feature comprises the unique feature of the service function in the service, wherein the contents involved in the verification question and the standard answer comprise the unique feature of the service function in the service; and
generating the verification question and the standard answer when the service feature comprises an attribute of other service on the same platform as the service, wherein the contents involved in the verification question and the standard answer comprise the content of the other service on the same platform as the service.

11. The server according to claim 8, wherein the one or more programs further comprise an instruction for performing the operation of:
selecting a verification question and a standard answer for verification with the terminal from the generated verification questions and standard answers according to the service request.

12. The server according to claim 11, wherein the one or more programs further comprise instructions for performing the operations of:
acquiring a service usage record corresponding to a user using the terminal according to the service request, the service usage record including a service function most frequently or most recently used by the user; and
selecting the verification question and the standard answer for verification with the terminal according to the service usage record.

13. The server according to claim 8, wherein the one or more programs further comprise instructions for performing the operations of:
sending the verification question to the terminal;
receiving an answer to the verification question from the terminal;
detecting whether the received answer is consistent with the standard answer; and
providing a service when a detection result indicates that the received answer is consistent with the standard answer.

14. The server according to claim 8, wherein the one or more programs further contain instructions for performing the operations of:
sending the verification question and the standard answer to a server, such that the server interacts with the terminal to complete the verification process.

15. A verification system, comprising a service data center, a server and a terminal, wherein the service data center and the server are connected to each other over a wireless or wired network, the server and the terminal are connected to each other over a wireless or wired network, and the service data center and the terminal are connected to each other over a wireless or wired network; and
the service data center is configured to: receive a service request from a terminal; acquire service data according to the service request received from the terminal, the service data being a set of service features of a service requested by the terminal; generate a verification question and a standard answer according to the service data; and send the verification question and the standard answer to a server, such that the server interacts with the terminal to complete a verification process.
